(19) United States
(12) Patent Application Publication
(10) Pub. No.: US 2018/0347200 A1
(43) Pub. Date: Dec. 6, 2018

(54) Privacy Screen

(71) Applicant: Judith A. Hooper, Big Rapids, MI (US)

(72) Inventor: Judith A. Hooper, Big Rapids, MI (US)

(21) Appl. No.: 15/613,167

(22) Filed: Jun. 3, 2017

(51) Int. Cl. E04F 10/04; E01F 7/02; G09F 15/00

(52) U.S. Cl. CPC E04F 10/04; A47G 5/00; G09F 15/0012; E01F 7/025

(57) ABSTRACT

An outdoor privacy screen for space-dividing residential and commercial landscapes that is free standing and stable; manually moveable; easily assembled and dismantled by means of retractable-pin spring-clip fasteners; having a metal frame and weighted, detachable base foot components; and, with innovatively, quick-release snap fasteners that attach to a series of horizontal bars in vertical arrangement, each of which suspends, for breeze-propelled, independent and not interconnected for motion, ultraviolet-ray protective, individual, decorative fabric panels that are easily secured, removed, and interchanged by means of sliding a panel's top hem pocket onto and across said bar. Fabric panel bottom edges slightly overlap each other in louver arrangement affording privacy; sunlight mitigation; and, airflow allowance for the creation of a wind resistant privacy partition.

### FIELD OF THE INVENTION

The present invention relates to privacy screens, more particularly to outdoor, manually moveable, decorative, sunlight mitigating, and wind resistant, space-dividing partitions that offer easy assembly for both residential and commercial environments.

### BACKGROUND OF THE INVENTION

As urban populations grow and the trend for outdoor living becomes a staple for homeowners and renters alike, the need for out-of-doors privacy has never been greater. The U.S. Census Bureau reports that as of 2012, 80.7 percent of the population resided in urban areas. Moreover, while homes have been increasing in size, lots have been decreasing. Similarly, the Apartment and Condominium Construction industry has been experiencing one of the fastest expansions within the construction sector. In their personal landscapes, everywhere, people are in closer proximity to one another and in need of privacy.

Also, there is a trend to bring the indoors, out, by creating outdoor landscapes that are well-designed, comfortable retreats. In 2016, The Institute of Architects reported that the outdoor living market expected to top $7.1 billion by 2020. Consumers desire relaxing, personal spaces with lighting and furnishings, including privacy partitions that decoratively enhance views or, in some cases, screen undesirable vistas.

Important, too, for outdoor living is a means to limit exposure to skin cancer-causing, ultraviolet (UV) rays. Identifying adequate shading devices for outdoor living environments is a concern.

Taking advantage of these outdoor spaces on fair-weather days means that privacy, decorative, and at least partially sun-shielding privacy screens are required to function in breezes and winds that often arise on the sunniest occasions. Outdoor space-dividers need to be wind resistant and stable under such conditions.

There exists, across industries, a variety of devices that include parts addressing the aforementioned needs relative to an effectively functioning outdoor privacy screen. However, no product or disclosure addresses all of these requirements in a single, successful invention.

Prior art discloses outdoor, manually moveable and portable privacy screens, windscreens, and sunshades, among others. Privacy is usually achieved by tensioning one or more, large, flexible i.e., fabric panels to a frame. However, tensioned panels are not wind resistant and in breezy conditions, such screens become unstable. And, recommendations for leg bracing via sandbags or other weights is unwieldy and unattractive. In addition, although large, flexible panels may be removable from their frames, they are costly to replace, difficult to clean, and offer fewer design alternatives than the smaller, easily removable panels of the present invention. U.S. Pat. No. 5,553,648 (Goharjou; Sep. 10, 1996) discloses a portable wall system with flexible sheet half-moon cut flaps. However, wind slits are negligible in wind force abatement.

Fixed, e.g., bolted down, clamped on, etc., outdoor deck partitions and balcony shields exist in prior art. These types rely on the structural integrity of their foundations or supports for stability. Compromised deck flooring or balcony railing inhibits the safe functioning of these types. And, unlike the present invention, fixed types lack mobility to provide light deflection as the sun changes position throughout the day. U.S. Pat. No. 6,513,566 B2 (Larin; Feb. 4, 2003), discloses a balcony railing-affixed shielding device with two flexible panels.

Outdoor, wind-resistant, multi-panel products exist in prior art such as traffic shields and fence products. These barriers are unrelated to the functional privacy the present invention assumes. U.S. Pat. No. 8,973,645 B1 (Cannova; Mar. 10, 2015) discloses a portable wind-resistant traffic screen wherein “The screen partially disengages . . . for the purpose of reducing wind pressure . . . .”

Devices with flexible fabric, louver-arranged panels for permitting airflow, and wind resistance, where the lamellae are not interconnected for motion, exist ranging from windbreakers to insect screens. However, prior art discloses no invention that allows air to pass between flexible-fabric louver-arranged panels ensuring resistance to wind gusts such as the present invention assumes. U.S. Pat. No. 4,432,381 (Greenbaum; Feb. 21, 1984) discloses a windbreaker secured to a frame.

Prior art discloses indoor, space-dividing privacy partitions with flexible frame covers typically designed for venues such as: offices, hotel rooms, and, production facilities. Prior art reveals no invention incorporating both mobility and a decorative mix-and-match, multi-panel function such as the present invention assumes. U.S. Pat. No. 6,354,043 B1 (Simon et. al, Mar. 12, 2002) discloses an office partition of draped fabric panels reliant on a fixed frame.

Prior art reveals inventions incorporating quick-release snap fasteners for attaching flexible sheets to solid substrates in devices such as boat covers and display frames among others. No prior art reveals a quick-release, panel fastening system such as the present invention assumes. U.S. Pat. No. 4,471,548 (Goudie; Sep. 18, 1984) discloses a display frame wherein snap fasteners work in conjunction with stabilizing flat bar (see FIG. 13), but the device is not a privacy screen in character.

The present invention's features are easily distinguishable from these and other devices. None of the above devices, taken either singly or in combination, provides a privacy screen for outdoor, residential and commercial use such as the present invention assumes.

The present invention was developed of tubular aluminum, solid aluminum bar, solid steel foot components, and fabric panels for a free-standing and stable; manually moveable; easily assembled frame incorporating releasably-fastened, frame-attached elements suspending a series of mix-and-match, flexible, louver-arranged panels that afford privacy, mitigation of sunlight, and an allowance for air flow thus creating a wind resistant privacy screen.

### OBJECTS OF THE INVENTION

It is the object of the invention that the privacy screen be both for residential and commercial use.

It is another object of the invention that the privacy screen affords stability and wind resistance by incorporating weighted base foot components.

It is another object of the invention that the privacy screen affords stability and wind resistance by arranging fabric panels in an airflow-permitting louver configuration.

It is another object of the invention that the privacy screen is manually moveable and easy to assemble.

It is another object of the invention that the privacy screen affords concealment by fastening and suspending fabric panels in louver arrangement.

It is another object of the invention that the privacy screen mitigates harmful UV sunlight by partially accommodating the changing angle of the light throughout the day by means of screen mobility and ultraviolet-ray protective, fabric panels.

It is another object of the invention that fabric panels for outdoor screen use be constructed of standard outdoor awning or woven PVC coated polyester fabric.

It is another object of the invention that the privacy screen enable decorative function flexibility by incorporating multiple, detachable, interchangeable, and replaceable fabric panels that are easy to maintain and cost effective to replace.

It is another object of the invention that the privacy screen be available with quick-release snap fasteners that secure metal bar held fabric panels to vertical tube members of said structural frame.

It is another object of the invention that the privacy screen be modular by enabling outer edge vertical members of one screen to fit snugly to side-by-side outer edge vertical members of one or more additional screens.

The present invention is a single structure frame with foot components and comprised of: metal tubing, square bar, and plate; bolts; bolt-less right angle connectors; retractable-pin spring-clip fasteners; grip knobs; quick-release snap fasteners; and, frame-detachable metal flat bars that support hanging, flexible fabric privacy panels.

The privacy frame panels are made of non-transparent, ultraviolet-ray protective, solution-dyed acrylic awning or PVC coated polyester mesh fabric. Panel fabrics are easy to clean; and, sun and mildew resistant.

When assembled, the privacy frame is supported by two sets of solid-metal, foot components i.e., a base plate with welded arch and bolted foot post; frame-attached by sliding said post into the lower frame vertical tube bottom end and securing said post, tube, and arch by a hand-tightened grip knob. A second set of foot components is likewise secured to a second vertical tube bottom end. Spring-clip fasteners inserted into lower frame vertical tube upper ends are in turn spring-clip fastened to two longitudinal tube frame member lower ends. Longitudinal frame tubes are thus connected to the lower frame section.

Spring-clip fasteners are then inserted into two longitudinal tube frame member upper ends that in turn spring-clip to upper frame vertical tubes. The rectangular frame with foot components is thus assembled. Five fabric panels are then hem-slid onto five metal flat bars. Each metal flat bar is independently, quick-released fastened to the frame face at regular intervals.

The assembly of the invention is comprised of approximately eight simple steps including base feet assembly, i.e., bolting foot posts to base plates; connecting foot posts and base plate arches to the lower frame section via hand-tightened grip knobs; spring-clip fastening longitudinal side tubes to both the lower and upper frame tube sections; sliding fabric panels over respective metal flat bars; and, quick-release fastening metal flat bars to said frame.

### BRIEF DESCRIPTION OF THE DRAWINGS

By way of example, reference will now be made to the accompanying drawings, which are not to scale.

FIG. 1 depicts a front overview diagram of the invention assembled with fabric panels attached.

FIG. 2 depicts a front view and conceptual embodiment of the invention assembled with snap detachable horizontal flat bars with cap and post (female) snap fastener components visible.

FIG. 3 depicts a rear view and conceptual embodiment of the invention assembled with spring-clip fastener buttons visible.

FIG. 4 depicts a side view and conceptual embodiment of the invention assembled with fabric panels attached.

FIG. 5 depicts a rear view and conceptual embodiment of the frame top section, with right angle connectors, spring-clip fasteners, vertical tube hole to accept spring-clip fastener retractable spring button, and spring-clip fastener inserted.

FIG. 6 depicts a rear view and conceptual embodiment of the frame bottom section, spring-clip fasteners, vertical tube hole to accept spring-clip fastener retractable spring button, and spring-clip fastener inserted.

FIG. 7 depicts a close-up of a bolt-less, right angle connector, horizontal tube open end and vertical tube top open end to accept right angle connector angles.

FIG. 8 depicts a close-up of a spring-clip fastener.

FIG. 9 depicts a rear view and is a conceptual embodiment of the longitudinal side tube, tube top and bottom open ends, and tube rear holes to accept spring-clip fastener retractable spring buttons.

FIG. 10 depicts a close-up of snap fastener components, i.e. cap and post (female) and socket (female); and, screw stud (male) and tube with front face hole for inserting screw stud (male) 7 snap fastener.

FIG. 11 depicts a rear view and is a conceptual embodiment of the frame top section, longitudinal side tubes, and frame bottom section with spring-clip fastener frame assembly means.

FIG. 12 depicts a front view and is a conceptual embodiment of the frame bottom section and foot components with foot components assembly and connection to frame bottom section means.

FIG. 13 depicts a front view and is a conceptual embodiment of the frame top section right angle connector, vertical tube, and longitudinal side tube with frame top section vertical tube and longitudinal front face tube holes for inserting screw stud (male) snap fastener components.

FIG. 14 depicts a front view and is a conceptual embodiment of the frame top section and longitudinal side tubes with screw stud (male) snap fastener components attached.

FIG. 15 depicts a front view and is a conceptual embodiment of the horizontal metal flat bar with two elongated slots to accept cap and post (female) and socket (female) snap fastener components.

FIG. 16 depicts a top view and is a conceptual embodiment of the horizontal metal flat bar with cap and post (female) and socket (female) snap fastener components attached.

FIG. 17 depicts a front view and is a conceptual embodiment of the fabric panel slid onto a horizontal metal flat bar.

The same reference numbers will be used throughout the drawings and the following description to refer to the same or like parts.

### DETAILED DESCRIPTION OF THE INVENTION

A problem in the market exists that there is no outdoor, independently stable, easily moveable, space-dividing residential and commercial privacy screen that offers within a single invention, sunlight mitigation, wind resistance; and, interchangeable, cost effective, decoratively changeable, louver configured, releasably-fastened, flexible panels. The various embodiments of the privacy screen herein are designed for outdoor residential and commercial use. However, the screen may be utilized to accommodate indoor privacy needs as well. For example, in addition to outdoor residential use on patios, decks, and in the landscape, among other locations, the screen may be used indoors to provide privacy within rooms and spaces where division, retreat, or a measure of solitude is desired. Consumers may select among a variety of frame, panel colors, and materials dependent upon preference and application.

Commercially, the privacy screen may be used outdoors in a variety of venues where some measure of separation from others is preferred. Outdoor seating for coffee shops and restaurants are primary examples. Indoor use might include situations where pharmacies arrange client privacy and retail stores provide fitting space partitions. Commercial organizations may incorporate their identities on screen frame panels as well as determine frame and panel colors. In all cases, both out-of-doors and indoors, the privacy screen is designed to be multi-functional, visually pleasing, high quality, and of moderate cost to consumers.

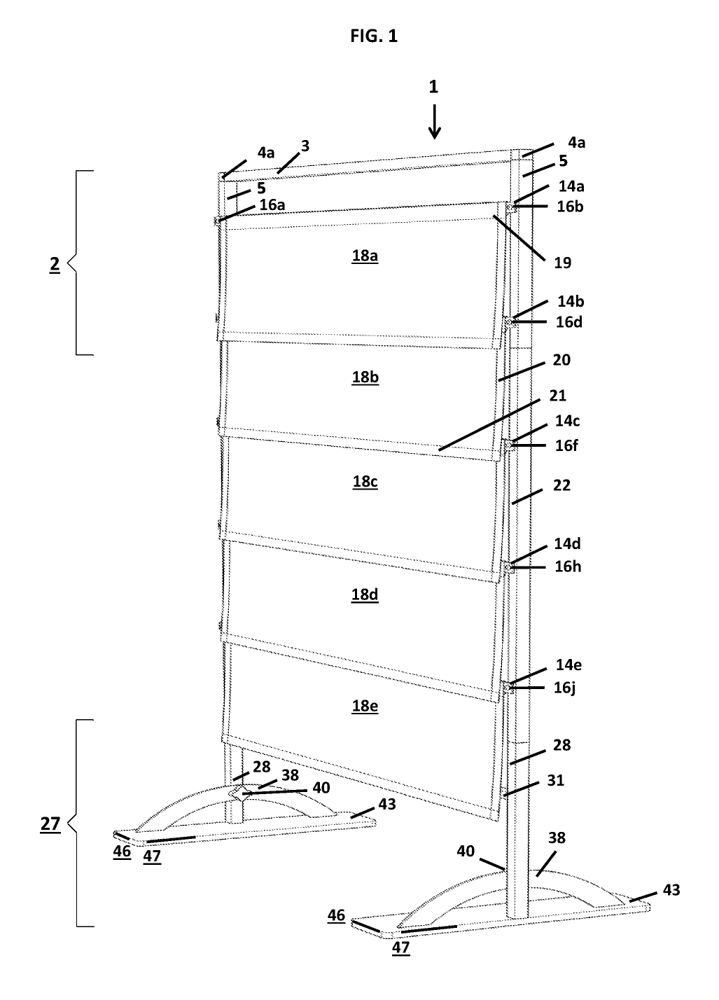

FIG. 1 is a conceptual embodiment of the best mode for carrying out the privacy screen invention comprised of a rectangular frame 1 with grip knob 40 secured foot components, i.e., base plate 43 with bolt-connected foot post 35 and weld-attached arch plate 38; and, five, fabric panels 18 individually suspended on elongated horizontal metal flat bars 14 mounted with cap and post (female) 16 and socket (female) 17 snap fastener components that fasten to the top frame vertical tubes 5 and longitudinal side tubes 22 screw stud (male) 7 mounted snap fastener components, such that each fabric panel 18 is frame suspended at regular intervals, one beneath the other in a slight, bottom-hem-edge 21 overlapping configuration to create a louver arrangement, where the panels 18 are not interconnected for motion, thus affording a blind configuration for privacy, mitigation of sunlight, and an allowance for air flow that enables a wind resistant privacy screen.

The privacy screen in the illustrated embodiment is modular in function as left top frame vertical tube 5 and left longitudinal side tube 22 and the left planar foot base plate 43 outside edges form a single vertical plane that allows two or more screens to snugly align when placed in a side-by-side configuration. In this embodiment, the frame with foot components can be up to 7 feet in height and up to 5 feet in width although these embodiments may be increased or decreased dependent upon the functionality desired.

With the above described structure, the left and right side frame tubes, connectors, foot components, horizontal flat bars, snap fastener components, and fabric panels are identical one to the other. However, with frame assembly, the two right angle connectors 4 and, the two sets of foot components, i.e., base plate 43 with bolt-connected foot post 35 and weld-attached arch plate 38 are grip knob 40 secured to the frame in mirror image of one to the other. In addition, although the left side frame tubes, connectors, foot components, topmost frame attached flat bar, snap fastener components, and fabric panel thereof will be described below, it is understood that the description to follow is equally applicable to the connection of the right side frame tubes, connectors, foot components, and all other frame attached flat bars, snap fastener components, and fabric panels.

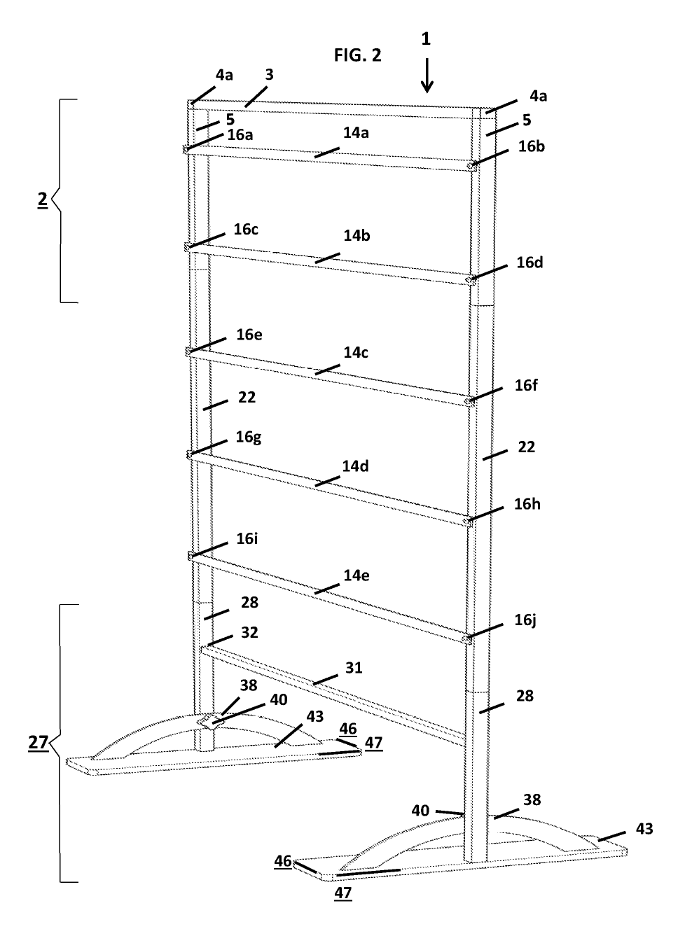

FIG. 2 depicts a front view and conceptual embodiment of the invention assembled with snap detachable 1″ W by 44″ L by ⅛″ thick horizontal flat bars 14 with cap and post (female) 16 snap fastener components visible; and, wherein five said bars 14 are frame snap fastened; and, wherein two said bars 14a and 14b fasten to the frame top section 2 vertical tubes 5 at approximately 4″ and 15″ down from the top frame horizontal tube 3 top edge, and three said bars 14c, 14d, and 14e fasten to the longitudinal side tubes 22 at approximately 27″, 39″ and 51″ down from the top frame horizontal tube 3 top edge.

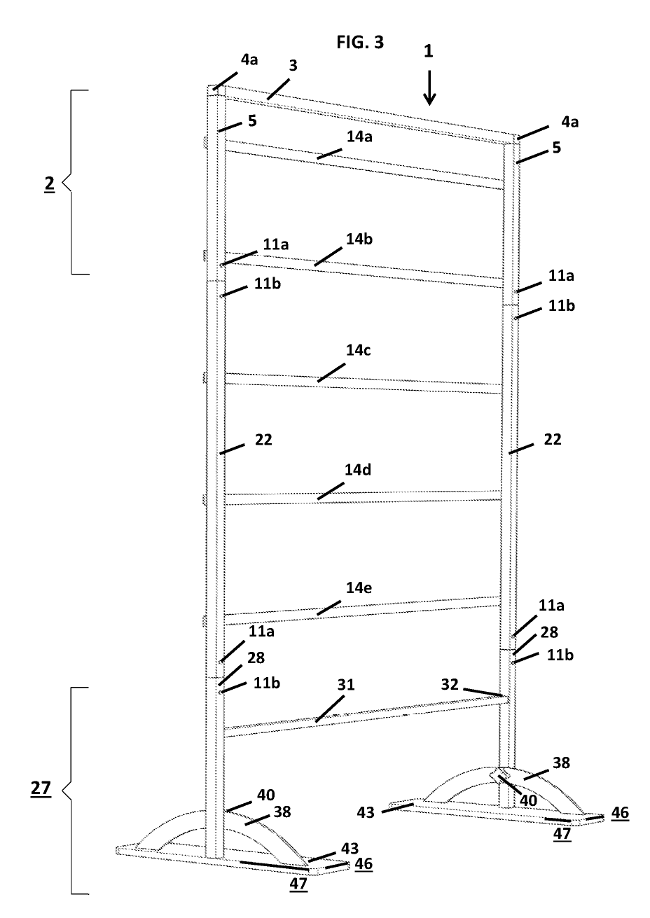

FIG. 3 depicts a rear view and conceptual embodiment of the invention assembled with spring-clip fastener 10 retractable spring buttons 11a and 11b visible.

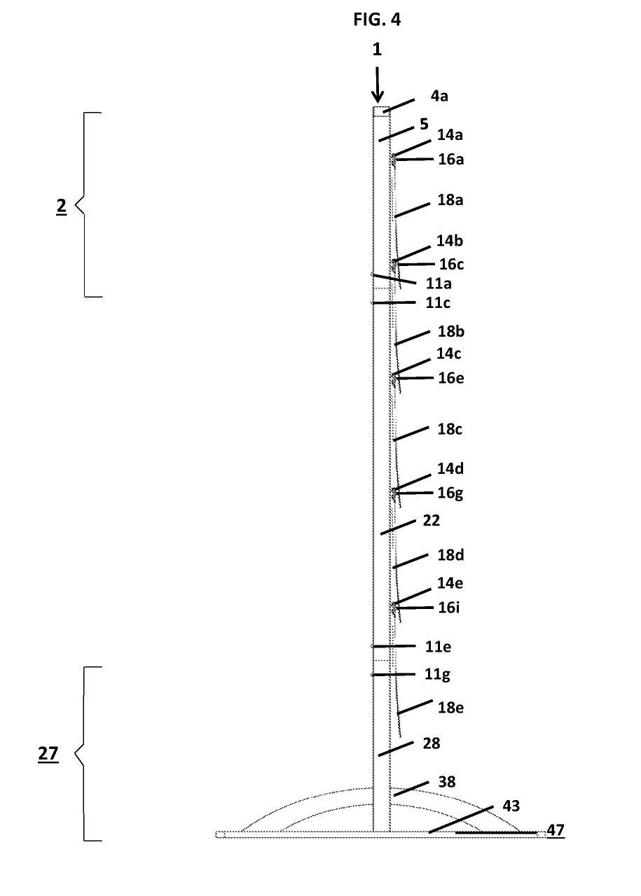

FIG. 4 depicts a side view and conceptual embodiment of the invention assembled with fabric panels 18 attached.

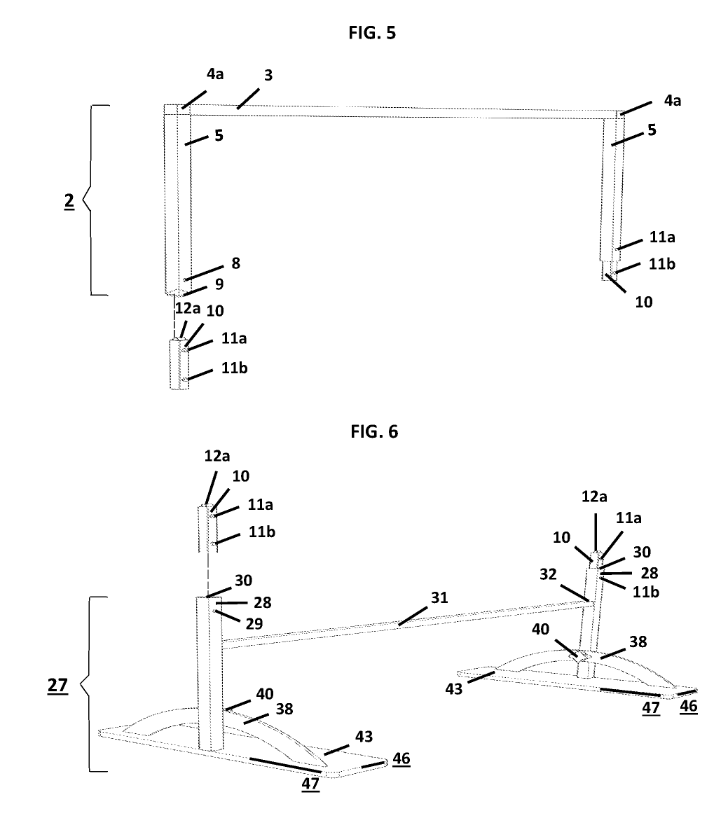

FIG. 5 depicts a rear view and conceptual embodiment of the frame top section 2 with mirror-image right angle connectors 4, spring-clip fasteners 10, left vertical tube hole 8 to accept spring-clip fastener 10 retractable spring button 11a; and, spring-clip fastener 10 inserted with retractable spring button 11a protruding through said right vertical tube 5; and, wherein a non-limiting example is, the frame top section 2 is constructed of three sections of 1″×1″ square hollow metal tubing, i.e., one horizontal tube 3, approximately 42″ long; and, an identical left and right vertical tube 5, approximately 17½″ high; and, said tubes to receive a left and right ninety-degree, a non-limiting example is, 1″ square profile, bolt-less, rigid nylon, right angle connector 4 with square corner endpoint 4b visible thus forming a right angle frame top section 2 of two, mirror image right angle connectors 4; and, wherein the rear face of each vertical tube 5 is identically modified by a single hole 8 drilled center space from left to right side on said tube 5 rear face, at approximately one inch from said tube 5 bottom open end 9, to accept a spring-clip fastener 10 retractable spring button 11a.

FIG. 6 depicts a rear view and is a conceptual embodiment of the frame bottom section 27, spring-clip fasteners 10, and left vertical tube hole 29 to accept spring-clip fastener 10 retractable spring button 11b, and spring-clip fastener 10 inserted with retractable spring button 11b protruding through said right vertical tube 28; and, wherein a non-limiting example is, the frame bottom section 27 is constructed of two sections of 1″×1″ square hollow metal tubing, i.e., an identical left and right vertical tube 28, approximately 17½″ high, welded at right and left vertical tube 28 inside face plane center points 32, approximately twelve inches from said tube bottom ends, to a ¾″ diameter square solid aluminum horizontal cross bar member 31, approximately 42″ long, and wherein the rear face of each bottom frame vertical tube 28 is identically modified by a single hole 29 drilled center space from left to right edge on said tube 28 rear face plane, at approximately one inch from said tube top end 30 to accept a spring-clip fastener 10 retractable spring button 11b.

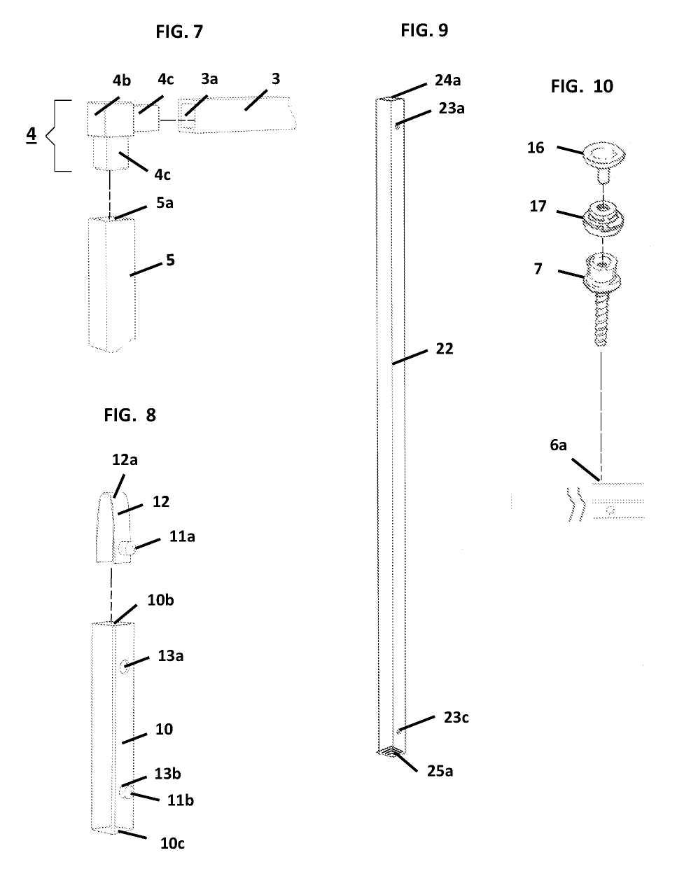

FIG. 7 depicts a close-up of a bolt-less, right angle connector 4, horizontal tube 3 open end 3a and vertical tube 5 top open end 5a to accept said connector right angles 4c; and, wherein a non-limiting example is a left rigid nylon, bolt-less right angle connector 4, with 1″ diameter square corner endpoint 4b visible upon frame assembly; and, wherein one of two adjacent right angles 4c is inserted into left horizontal tube 3 open end 3a and the second of two said angles is inserted into left vertical tube 5 left top open end 5a; thus forming the frame top section left right angle corner.

FIG. 8 depicts a close-up of a spring-clip fastener 10; and, wherein a non-limiting example is, said fastener 10 is constructed of an approximately ¾″ square hollow, zinc-plated, steel tube approximately 5″ in length; and, wherein said fastener 10 is identically modified by two single holes 13a and 13b drilled center space from left to right edge on said fastener 10 rear face plane and at one inch from each said fastener 10 end to accept said fastener 10 retractable spring pin button 11a and retractable spring pin button 11b; and, wherein said fastener top open end 10b is inserted with two identical spring pins 12 by sliding a first said spring pin 12 spring pin button 11b end into said fastener 10; and, wherein the first inserted spring pin 12 retractable spring pin button 11b protrudes from said fastener 10 rear face hole 13b, and sliding a second said spring pin 12 spring pin button 11a end into said fastener 10; and, wherein the second inserted spring pin 12 retractable spring button 11a protrudes from a second said fastener 10 rear face hole 13a; and, wherein the second spring pin 12 hoop end 12a of the second inserted retractable spring pin button 11a remains protruding from said fastener 10 top open end 10b. Four, identical, spring-clip fasteners 10 are utilized in frame assembly.

FIG. 9 depicts a rear view and is a conceptual embodiment of the left longitudinal side tube 22; tube top 24a and bottom 25a open ends; and, tube top rear 23a and bottom rear 23c holes to accept spring-clip fastener 10 retractable spring-pin buttons 11a and 11b; and, wherein a non-limiting example is, a left said tube 22, is constructed of 1″×1″ square hollow metal tubing, approximately 39″ in length, top open end 24a and bottom open end and color-coded at said bottom inside open end 25a to ensure correct said tube-to-frame assembly orientation; and, wherein the rear face of said tube 22 is identically modified by single holes 23a and 23c drilled center space from left to right edge on said tube 22 rear face, at one inch from each said tube 22 ends 23a and 23c, to accept said spring-clip fastener 10 retractable spring-pin buttons 11a and 11b.

FIG. 10 depicts a close-up of snap fastener components, i.e. cap and post (female) with socket (female); and, screw stud (male) and tube with front face hole for inserting screw stud (male) 7 snap fastener.

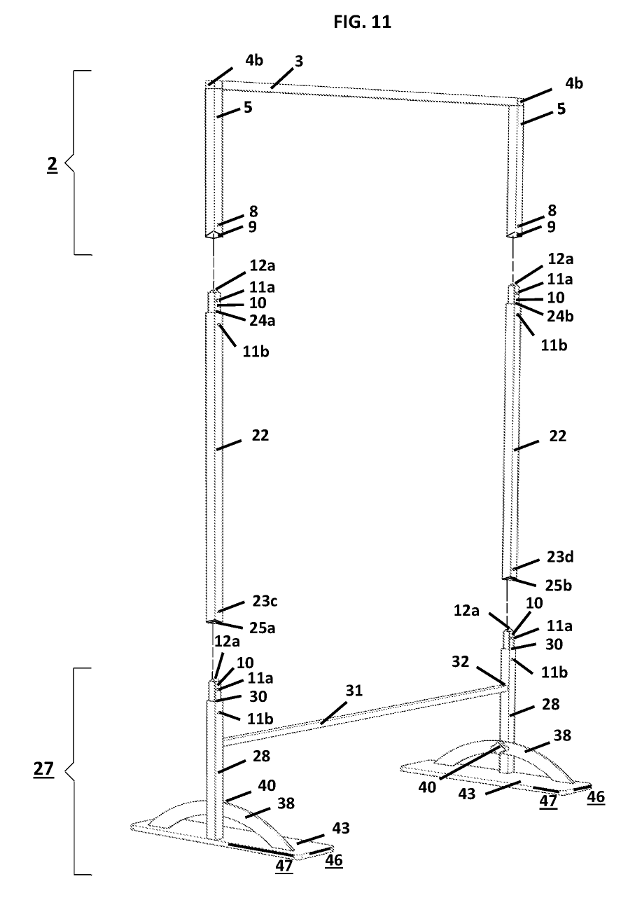

FIG. 11 depicts a rear view and is a conceptual embodiment of the frame top section 2, longitudinal side tubes 22, and frame bottom section 27 with spring-clip fastener 10 frame assembly means; and, wherein for connecting the left longitudinal tube 22 to the left top frame vertical tube 5, a non-limiting example is, a spring-clip fastener's 10 non hoop open end 10c is inserted into the left longitudinal side tube 22 upright top open end 24a such that retractable spring button 11b protrudes from longitudinal side tube 22 rear face hole 23a (FIG. 9); and, wherein said spring-clip fastener 10 hoop end 12a is inserted into the left top frame vertical tube 5 open end 9 such that the spring-clip fastener 10 retractable spring button 11a protrudes from the left top frame vertical tube 5 rear face hole 8 thus securing the left longitudinal side tube 22 to the left top frame vertical tube 5; and,

wherein, for connecting the left longitudinal tube 22, to the bottom left frame vertical tube 28, a non-limiting example is, the next spring-clip fastener 10 spring-pin non hoop open end 10c is inserted into the left bottom frame vertical tube 28 upright open end 30 such that the spring-clip fastener 10 retractable spring button 11b protrudes from the bottom frame vertical tube 28 rear face hole 29; and, wherein said spring-clip fastener 10 hoop end 12a is inserted into the left longitudinal side tube color-coded bottom open end 25a such that the spring-clip fastener 10 retractable spring button 11a protrudes from the left longitudinal side tube 22 rear face hole 23c (FIG. 9) and thus securing the left longitudinal side tube 22 to the left bottom frame vertical tube 28. The assembled frame is held in an upright position by foot components described below.

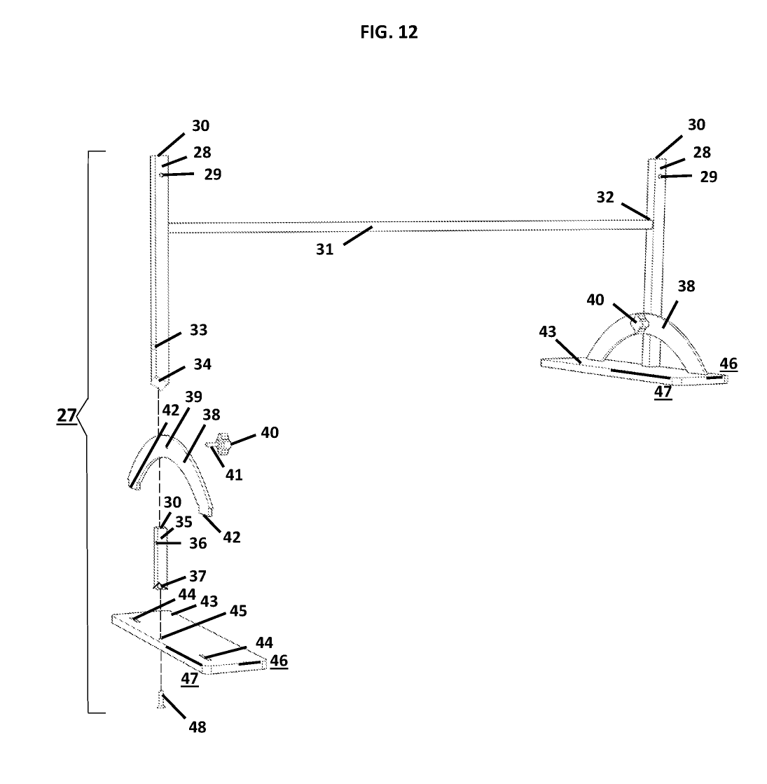

FIG. 12 depicts a front view and is a conceptual embodiment of the frame bottom section 27 and foot components, i.e., base plate 43 with bolt-connected foot post 35 and weld-attached planar arch plate 38; and, foot components assembly and connection to frame bottom section 27 means; and, wherein, a non-limiting example is, a left approximately 4½″ W by 21½″ L by ⅝″ thick, essentially rectangular, solid steel foot base plate 43, hole drilled with two approximately 1¾″ L by 3/16″ W by ⅜″ D elongated slots 44 placed with said 3/16″ W slot outside edge beginning at approximately 2″ from said plate width edge 46 and said 1¾″ L slot outside edge beginning at approximately 1″ from said plate longitudinal edge 47; and, wherein a left approximately 18½″ L by 2″ W by 3/16″ thick, 6″ mid-point high, curved steel planar arch plate 38 with two, 1½″ wide, right angle ends 42; and, wherein each said arch end 42 is inserted into each said slot 44 and spot welded on the inside bottom of said slot 44 thus permanently connecting said base plate 43 to said arch 38 at a ninety-degree angle to one another; and, wherein said arch 38 is single hole drilled at center space from left to right on said arch 2″ W face plane edges, and at center mid-point 39 from each said arch end 42; and,

wherein said left base plate 43 is also single hole drilled at approximately ½″ to the right of said plate 43 longitudinal midpoint 45 and longitudinal outer face edge 47; and, wherein a ¾″ diameter, square solid steel left foot post 35 approximately 5¾″ high, single hole drilled on its inside face plane 36 and at approximately 5″ from said post bottom end 37 to a depth of approximately ½″; and, wherein said post 35 is also single hole drilled on its bottom face center point 37 to a depth of approximately ⅜″; and, wherein said post 35 is secured to a left base plate 43 by aligning said post bottom face center point hole 37 with said base plate 43 hole 45 and by positioning said foot post 35 outside face plane parallel with said base plate 43 longitudinal edge 47 and by inserting a 5/16″ diameter hex bolt 48 up through the bottom of the left foot base plate 43 hole 45 and into the left vertical foot post 35 bottom center face hole 37 and allen-wrench tightening said bolt 48 thus securing the left foot plate 43 to the left foot post 35, in a ninety-degree relation to one another, such that said post 35 may be placed in a vertically upright position; and,

wherein to secure the left bottom frame vertical tube 28 to left foot components, a non-limiting example is, a left bottom frame vertical tube open bottom end 34 is slid over and onto a left foot post 35 vertically upright end 30 thus aligning the bottom frame vertical tube 28 inside face hole 33; foot post 35 inside face hole 36; and, planar arch plate 38 hole 39; and, wherein a 1¾″ diameter grip knob 40 with an approximately 5/16″ diameter 18 thread, and approximately ½″ long screw thread 41 is inserted through the planar arch plate 38 hole 39; bottom frame vertical tube 28 hole 33 and into the aligned foot post 35 hole 36 such that said bottom left frame vertical tube 28 is connected to left foot components, i.e., base plate 43 with bolt-connected foot post 35 and weld-attached planar arch plate 38.

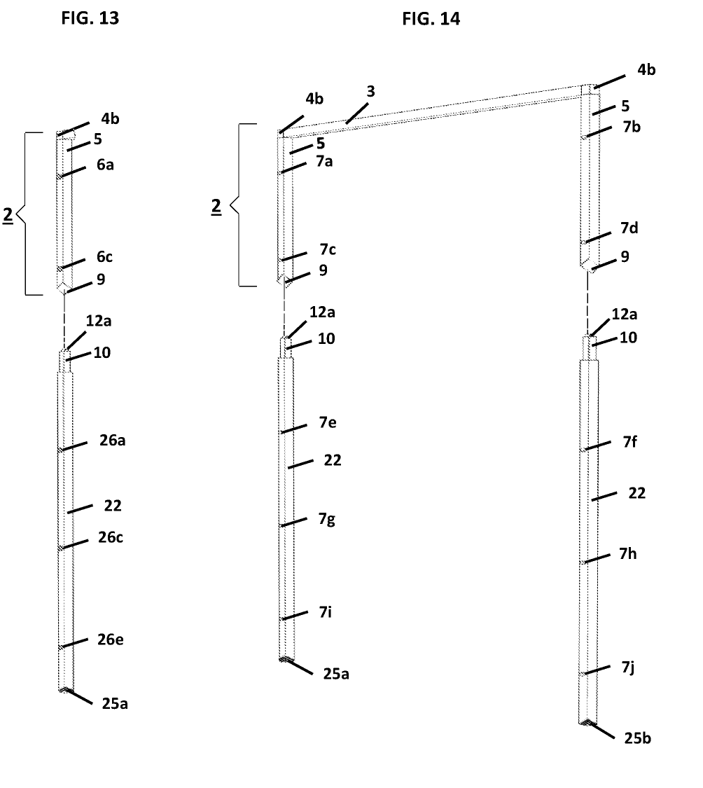

FIG. 13 depicts a front view and is a conceptual embodiment of the frame top section left side, right angle connector 4, left vertical tube 5, and left longitudinal side tube 22 with said vertical tube 5 front face tube holes 6a and 6c, and said longitudinal tube 22 front face tube holes 26a, 26c, and 26e for inserting screw stud (male) 7 snap fastener components; and, wherein, a non-limiting example is said vertical tube 5 front face is modified by a single hole drilled 6a at 4½″ down from the top-of-frame outside edge and 6c at 15½″ down from said edge, and said longitudinal side tube 22 front face is modified by a single hole drilled 26a at 27½″, 26c at 39½″, and 26e at 51½″ down from said edge; and, wherein vertical tube 5 holes 6a and 6c; and, longitudinal tube 22 holes 26a, 26c, and 26e are center spaced from left to right edge on said vertical tube 5 and said longitudinal tube 22 front face planes and left said holes 26a, 6c, 26a, 26c, and 26e are also spaced in vertically equidistant relation one to the other.

FIG. 14 depicts a front view and is a conceptual embodiment of the frame top section 2; and, vertical side tubes 5 and longitudinal side tubes 22 with screw stud (male) 7 snap fastener components attached; and, wherein a non-limiting example is for permanent mounting by screwing in a heavy duty, stainless, self-tapping #10 7/16″ screw stud 7 is used; and, whereby left vertical tube hole 6a and 6c is inserted respectively with corresponding said studs 7a, 7c; and, left longitudinal tube hole 26a, 26c, and 26e is inserted respectively with corresponding said studs 7e, 7g, and 7i; and, wherein each stud is center spaced from left to right on said vertical tube 5 and said longitudinal tube 21 front face planes and all said left studs are mounted in vertically equidistant relation to one another on said vertical 5 and longitudinal 21 tube front face planes.

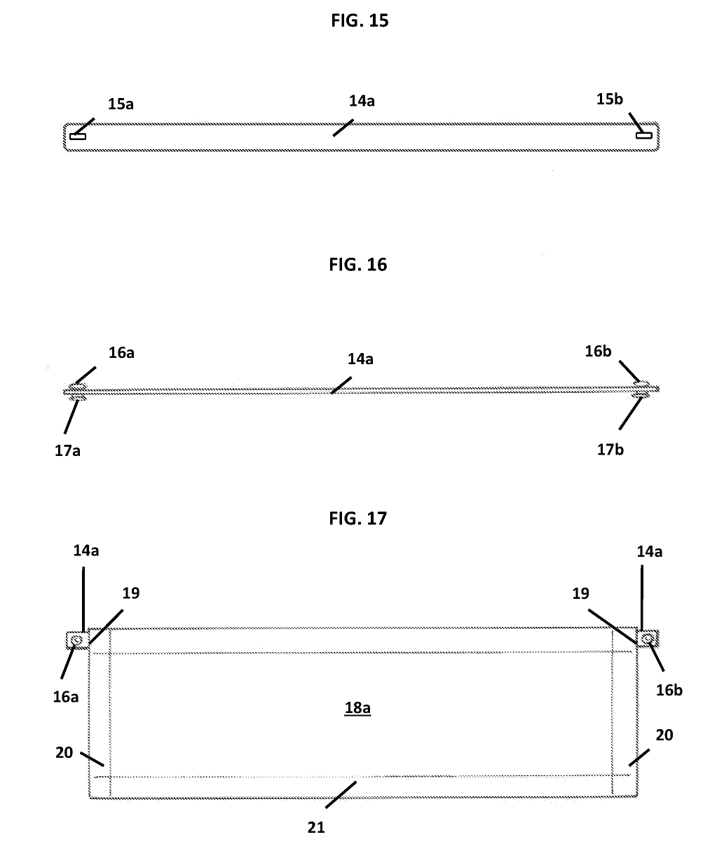

FIG. 15 depicts a front view and is a conceptual embodiment of the topmost horizontal metal flat bar 14a drilled with two elongated slots 15a and 15b to accept cap and post (female) 16a and 16b, and socket (female) 17a and 17b snap fastener components sets; and, wherein a non-limiting example is a rigid horizontal metal flat bar 14a, weighing approximately 1.3 lbs., and approximately 1″ wide×44″ long×⅛″ thick is modified by a single hole drilled at approximately ½″ from each said bar 14a end and at center space from said bar 14a top and bottom edges 15a and 15b for the creation of two 11/64″ elongated slots 15a and 15b; and, wherein insert through said slots 15a and 15b of said bar 14a front face plane, 24/cap, 5/16″ brass nickel plate said posts 16a and 16b; and, by the use of a snap fastener tool, permanently join each said post 16a and 16b to a corresponding hard action brass nickel plate socket 17a and 17b placed on said bar 14a rear face plane bar slots 15a and 15b; and, wherein to fasten said posts 15a and 15b to said sockets 16a and 16b at such a pressure to create certain slight lateral movement of said cap and post (female) 16a and 16b, and correspondingly joined socket (female) 17a and 17b snap fastener components.

FIG. 16 depicts a top down or “birds-eye” view and is a conceptual embodiment of the topmost horizontal metal flat bar 14a with cap and post (female) 16a and 16b and socket (female) 17a and 17b snap fastener components sets attached; and, wherein said bar 14a is quick release frame attached by aligning said socket (female) 17a and 17b snap fasteners with corresponding screw stud (male) snap fastener components 7a and 7b; and, wherein hand pressure is applied to said caps 16a and 16b; and, wherein said sockets 17a and 17b are thus interlocked with said studs 7a and 7b for said bar 14a stability and quick frame release.

FIG. 17 depicts a front view and is a conceptual embodiment of the topmost fabric panel 18a slid onto horizontal metal flat bar 14a; and, wherein a non-limiting example is, a fabric panel 18a approximately 42″ wide and 12″ high modified to include an elongated horizontal open pocket top hem 19, two perpendicular vertical side hems 20, and an elongated horizontal bottom hem 21 is fastened to the topmost horizontal metal flat bar 14a by sliding the elongated horizontal open pocket top hem 19 onto said bar 14a; and, wherein fabric panel 18a is frame-held in place; and, wherein each said panel being hung is at regular, horizontal flat bar 14 and snap-fastener controlled intervals, one below the other, independent and not interconnected for movement, and with bottom hems 21 in slight overlap for louver configuration and breeze-propelled motion; and,

wherein a non-limiting example is, flexible panels 18 are made of ultraviolet-ray protective, solution-dyed acrylic awning fabric or a PVC coated polyester mesh fabric. Panel fabrics are easy to clean with a mild soap and water; and, are sun and mildew resistant.

### Construction

Various embodiments of the privacy screen may be constructed of a lightweight rigid frame with flexible panel material. For example, in some embodiments, the frame may be constructed of 1½″×1½″ or 2″×2″ hollow aluminum tubing, 1″×1″, 1½″×1½″ or 2″×2″ hollow steel tubing; solid aluminum, steel, or polycarbonate bar; or, wood, among others. Frame finishes may be embodied as anodized and powder coated; and, textured or smooth among others. Frame color may be embodied across the full range of industrial offerings as well as colors uniquely created for the invention herein. In some embodiments, the height and width of the frame may vary per the specific residential, commercial, outdoor, or indoor application. Likewise, horizontal, flat bar supports may vary in length, width, or thickness to accommodate specific applications. For example, aluminum, polycarbonate, acrylic, steel, and wood bars are among the embodied materials that may secure flexible panels to the frame. Flat bar supports may also embody varied finishes and colors in the same manner as the frame. Frame top section right angle connectors may be also be embodied as various colors and types including spring-clip, bolt, or rivet, among others. Likewise, right angle connector material may be nylon, plastic, aluminum, steel, or composite materials. Frame tube spring-clip fasteners may be embodied as zinc-plated steel, aluminum, or a combination of nylon and zinc-plated steel, among other materials. Said frame tube fasteners may also vary in type and be embodied as hinged or telescoping among others.

Further, privacy screen flexible panel embodiments forming a louver configuration may be constructed of any size or shape. Embodiments including various numbers of panels on a frame; and or, the length, width or height of panels may vary per application. Panels may be horizontal bar attached by open pocket hem-sliding onto said bars, but also by such other means, but not limited to, folding a panel top hem edge over said bar and securing said panel with hook and loop fastening tape; snap fasteners; magnets; grommets; and, buttons; or other such embodiments that allow the panel to be easily disengaged from its support bar. In another embodiment, a narrow, approximately ¾″ wide by 42″ long, lightweight, polycarbonate strip, or other type of stiffening material affording “ballast” may be inserted into a flexible fabric panel horizontal open pocket bottom hem as a means to provide a measure of panel strengthening and or rigidity.

Panels of different colors, shapes, designs, and various straight and scallop edges among others, may be constructed. Die cutouts within panels may be embodied. Double layer panels of different materials, the same materials, intact or cutout to reveal one material behind the other are among the possible embodiments. Panel material may be opaque, translucent or in some circumstances and to a degree, transparent. Panels may be printed on a single side or both sides.

Likewise, in some outdoor privacy frame panel embodiments flexible fabrics may include, but are not limited to, printed acrylics, acrylic-coated polyesters, cotton-polyester blends, vinyl-coated synthetic fiber mesh, olefin, and, canvas e.g., cotton, linen, polyester, acrylics and blends of these materials; and, coated, woven polyester, back-lit textiles among possible types. Similarly, indoor privacy screen flexible materials embodiments may consist of a variety of standard drapery or upholstery fabrics that comply with U.S. government textile industry safety standards and regulations for indoor fabric applications. Panel weights and thicknesses may vary as well. Frame and panels may be enhanced with a wide range of embellishment and trim embodiments. For example, fabric, metal, plastic and wood ornamentations and trims may be applied to any part of the frame, foot base assembly, panel support, or panel itself.

Privacy screen fasteners that secure metal bar held fabric panels to the longitudinal frame members, i.e., quick-release snap fastener components in the present embodiment, may vary to include, but are not limited to, other quick release types such as magnetic; turn; rivet; and, hook and loop fasteners. Various, but not limited to, non-quick release type fasteners may also be embodied such as rivets, bolts, and screws.

The solid steel planar foot base plate, foot base arch, and foot post component material, weights, dimensions, and shapes, embodied in the present invention, are designed to support the frame depicted herein. Alternate material, weight, dimension, and shape embodiments may be assumed given changes in the privacy screen i.e., frame or panel dimensions, and or materials, and or applications. Possible foot component embodiments may include a foot base plate, foot base arch, and foot post constructed of, but not limited to, a polycarbonate or similar material that is molded for a hollow interior that may be filled with material such as, but not limited to, sand or water.

Other foot base plate, foot base arch, and foot post component embodiments may include a range of designs, including but not limited to, foot base plate perforations that enable securing to a foundation, and; base plate and arch raised embossments, or die cutouts any of which provide decoration and or identification, may be embodied. Foot base plate, foot base arch, and post finishes may also be embodied as anodized, powder coated, textured, and smooth, among others. Colors may be embodied across the full range of industrial offerings as well as colors uniquely created for the invention and its various exemplary embodiments herein.

The outdoor privacy screen functions efficiently indoors, both residentially and commercially. For indoor applications, substitution of the foot components of the present invention, for a lighter-weight planar foot base plate, foot base arch, and or foot post with or without foot base plate and or arch perforations, raised embossments, or die cutouts are examples of alternative embodiments.

Finally, the grip knob with screw thread of the present invention, for securing privacy screen foot posts to the frame, may also be embodied in a variety of shapes, sizes, colors, and materials.

Although the above description contains many specifics and embodiments, including those depicted in the accompanying figures, such embodiments merely illustrate and are not restrictive to the broad, present invention, and this invention is not limited to those specific constructions and displays given that those skilled in the art may employ various other modifications within the scope of the following Claims.

The invention claimed is:

1. A frame comprising:
a top frame section comprising a horizontal square tube, right angle connected to identical first and second vertical square tubes.
a bottom frame section comprising a square horizontal cross bar connected to identical first and second vertical square tubes.
a first vertical square side tube attached to a first said top frame vertical tube and to a first said bottom frame vertical tube.
a second vertical square side tube, identical to said first side tube, attached to a second said top frame vertical tube and to a second said bottom frame vertical tube.
a first foot attached to a bottom frame first vertical tube, and wherein said foot comprises a planar base plate with vertically connected foot post and vertically connected planar arch plate.
a second foot attached to a bottom frame second vertical tube, and wherein said foot comprises a planar base plate with vertically connected foot post and vertically connected planar arch plate.

2. The frame of claim 1, wherein said top frame section comprises two identical right angle connectors that attach said horizontal tube to said top frame section identical first and second vertical tubes, at two angles of ninety-degrees relative to said horizontal tube and said top frame section first and second vertical tubes.

3. The frame of claim 1, wherein said top frame section vertical tubes, said vertical side tubes, and said bottom frame vertical tubes comprise spring-clip fastener, retractable spring-pin button receptor holes.

4. The frame of claim 3, wherein said top frame section vertical tubes, said side vertical tubes, and said bottom frame vertical tubes comprise attaching to one another by inserting a spring-clip fastener into said top section top; said side top and bottom; and said bottom section top; tube open ends; and, wherein a said spring-clip fastener, retractable spring-pin button protrudes through each said pin button receptor hole.

5. The frame of claim 4, wherein said spring-clip fastener, retractable spring-pin buttons can only be attached to said top frame vertical tubes, said side vertical tubes, and said bottom frame vertical tubes at said spring-clip fastener, retractable spring-pin button receptor holes.

6. The frame of claim 1, wherein said top frame section said first and second; and, said first and second vertical side tubes comprise front face plane, male snap fastener screw stud component receptor holes located in vertically equidistant relationship to one another.

7. The frame of claim 6, wherein said top frame section said first and second; and, said first and second vertical side tubes comprise said male snap fastener stud components screw attached for permanent mounting into said male snap fastener screw stud component receptor holes.

8. The frame of claim 7, wherein said male snap fastener studs can only be screw attached to said top frame vertical tubes and said vertical side tubes at said male snap fastener screw stud component receptor holes.

9. The frame of claim 1, wherein said horizontal cross bar comprises welding said bar ends to said bottom frame section vertical tubes inside face planes at an angle of approximately ninety degrees relative to said bottom frame section vertical tubes.

10. The frame of claim 1, wherein said planar foot base plate comprises an angle of approximately ninety degrees relative to bottom frame section vertical tubes.

11. The frame of claim 10, wherein said foot base plate comprises a single hole drilled for bolt attachment of said foot post.

12. The frame of claim 1, wherein said foot post comprises a single center bottom hole drilled for attaching said post to said foot base plate, and is at an angle of approximately ninety degrees relative to said foot base plate.

13. The frame of claim 10, wherein said foot base plate comprises two elongated slots for insertion of planar arch plate ends.

14. The frame of claim 13, wherein said arch plate comprises two ends welded at an angle of approximately ninety degrees relative to said foot base plate, and on the inside bottom of, said slots for permanent connection of said arch to said foot base plate.

15. The frame of claim 1, wherein said foot post, said arch plate, and said bottom frame section vertical tube comprise a hole for aligning and grip knob thread attaching said post, said arch, and said bottom frame section vertical tube to one another.

16. The frame of claim 15, wherein said foot post, said arch plate, and said bottom frame section vertical tubes can only be attached to one another at said foot post, said arch plate, and said bottom frame section vertical tube aligning holes.

17. A panel privacy assembly comprising:
a horizontal flat bar comprising first and second elongated receptor slots near each said bar end, and female snap fastener components
a fabric panel comprising vertical and horizontal hems

18. The panel privacy assembly of claim 17, wherein said flat bar comprises two elongated receptor slots of a size to make certain slight lateral movement of slot-connected female snap fastener components.

19. The panel privacy assembly of claim 18, wherein said slot comprises a female snap fastener cap and post; and, corresponding female snap fastener socket component joined to one another for permanent mounting of said cap and post; and, said socket to said elongated receptor slot.

20. The panel privacy assembly of claim 19, wherein said cap and post and corresponding said socket component can only be joined to one another at said elongated receptor slots.

21. The panel privacy assembly of claim 20, wherein said bar said socket comprises attachment to and quick release from said top frame section first and second vertical tubes and said first and second vertical side tubes by aligning said flat bar said cap and post with correspondingly joined said socket with corresponding said top frame section first and second vertical tube said screw stud and with said first and second vertical side tube said screw stud, and wherein pressure is applied to said cap and post cap's outside top plane; and, wherein said correspondingly joined said socket thus interlocks with, and is maintained for quick-release from, said male screw stud.

22. The panel privacy assembly of claim 17, wherein said flat bar comprises said bar socket protruding, back face plane placement transverse to, and at an angle of approximately ninety degrees relative to, top frame section first and second vertical tube and to said first and second vertical side tube front face planes.

23. The panel privacy assembly of claim 22, wherein said bar comprises a length wherein said bar extends end-to-end from, and is flush with, top frame section first and second vertical tube and said first and second vertical side tube front face plane vertical outside edges.

24. The panel privacy assembly of claim 17, wherein said flexible fabric panel comprises an elongated horizontal top hem, an elongated horizontal bottom hem, and two vertical side hems with said horizontal and said vertical hems at an angle of approximately ninety degrees relative to one another.

25. The panel privacy assembly of claim 24, wherein said panel comprises said horizontal top hem edge folded down and onto the upper horizontal back panel plane and wherein said horizontal hem top edge is joined to said fabric plane by sewing on top of, and from end to end of, said horizontal hem stitch line thus forming an elongated horizontal top pocket open hem.

26. The panel privacy assembly of claim 17, wherein said panel comprises an elongated horizontal top pocket open hem that slides onto said horizontal flat bar.

27. The panel privacy assembly of claim 26, wherein said panels comprise said flat bar suspension and said panels hang one below the other, in said panel front horizontal plane placement and at an angle of approximately ninety degrees relative to said top frame section first and second vertical tubes and said first and second vertical side tubes; and, at regular, controlled intervals, independent, and not interconnected for movement.

28. The panel privacy assembly of claim 27, wherein said panels comprise suspension with said elongated horizontal bottom hems in slight overlap for a louver configuration.

29. The panel privacy assembly of claim 17, wherein said flexible fabric panels are comprised of ultraviolet-ray protective material selected from a list of fabric or plastic.

30. The panel privacy assembly of claim 17, wherein said assemblies comprise five in number.
